(19) United States
(12) Patent Application Publication
(10) Pub. No.: US 2009/0107790 A1
(43) Pub. Date: Apr. 30, 2009

(54) Hydrodynamic Torque Converter Device for an Automotive Drive Train

(76) Inventors: Mario Degler, Baden-Baden (DE); Stephan Maienschein, Baden-Baden (DE); Jan Loxtermann, Baden-Baden (DE); Thorsten Krause, Buehl (DE)

Correspondence Address: SIMPSON & SIMPSON, PLLC, 5555 MAIN STREET, WILLIAMSVILLE, NY, 14221-5406, US

(21) Appl. No.: 12/084,742

(22) PCT Filed: Oct. 16, 2006
(86) PCT No.: PCT/DE2006/001815

§ 371 Date: May 9, 2008

(30) Foreign Application Priority Data
Nov. 10, 2005 (DE) 102005053603.4

(51) Int. Cl. F16H 45/02

(52) U.S. Cl. 192/3.29

(57) ABSTRACT

The invention relates to a hydrodynamic torque converter device (1) which comprises a torsional vibration damper (10), a converter torus (12) configured by an impeller (20), a turbine wheel (24) and a stator (22), and a converter lockup clutch (14), said torsional vibration damper (10) having two energy accumulating devices (38, 40). The invention is characterized in that the first energy accumulating device (38) is bridged at high torque loads. The bridging is effected by reaching a maximum first relative angle of twist, e.g. by the action of bow springs as the first energy accumulating device (38) locking up, thereby providing a good insulation of torsional vibrations both in the part-load range and due to the bridging by the first energy accumulating device (38) at higher torque loads.

### CROSS-REFERENCE TO RELATED APPLICATIONS

This application is the National Stage of PCT International Application No. PCT/DE2006/001815, filed Oct. 16, 2006, which application published in German and is hereby incorporated by reference in its entirety, which application claims priority from German Patent Application No. DE 10 2005 053 603.4, filed Nov. 10, 2005 which is incorporated by reference in its entirety.

### FIELD OF THE INVENTION

The invention relates to a hydrodynamic torque converter device for an automotive drive train, wherein the torque converter device comprises a torsion vibration damper, comprising a first energy accumulator means and a second energy accumulator means, a converter lockup clutch, and a converter torus formed by a pump shell, a turbine shell, and a stator shell.

### BACKGROUND OF THE INVENTION

FIG. 2 of German Patent No. DE 199 20 542 A1 shows a hydrodynamic torque converter device for a motor vehicle drive train, wherein the torque converter device comprises a torsion vibration damper, comprising a first energy accumulator means and a second energy accumulator means, and a converter lockup clutch, and a converter torus formed by a pump shell, a turbine shell, and a stator shell. Therein, an input component and an output component of the first energy accumulator means is provided, and an input component and an output component of this second energy accumulator means. According to FIG. 2 of DE 199 20 542 A1, on the one hand, the rotation angle between the input component and the output component of the first energy accumulator means is limited, and, on the other hand, the rotation angle between the input component and the output component of the second energy accumulator means is limited. FIG. 2 of DE 199 20 542 A1 shows that by means of this limitation of the respectively described rotation angles, the energy accumulators of the first or the second energy accumulator means are bridged at larger rotation angles and protected against possible detrimental influences at higher torque spikes.

### BRIEF SUMMARY OF THE INVENTION

The present invention is a hydrodynamic torque converter device broadly comprising a torsion vibration damper, a converter torus formed by a pump shell, a turbine shell, and a stator shell, and a converter lockup clutch. The torsion vibration damper comprises a first energy accumulator means and a second energy accumulator means. The first energy accumulator means comprises one or several first energy accumulators and the second energy accumulator means comprises one or several second energy accumulators.

An input component of the first energy accumulator means is provided, which forms support portions for the support or loading of the first energy accumulators at its respective first ends. Furthermore, an output component of the first energy accumulator means is provided, which forms support portions for the support or loading of the first energy accumulators at their second ends, which are opposed to the first ends. An input component of the second energy accumulator means is provided, which forms support portions for the support or loading of the first ends of the second energy accumulators. Furthermore, an output component of the second energy accumulator means is provided, which forms support portions for supporting or loading the second ends of the second energy accumulators, which are opposed to the first ends.

It is provided that the relative rotation angle of the input component of the first energy accumulator means relative to the output component of this first energy accumulator means is limited to a maximum first relative rotation angle. Furthermore, it is provided that the relative rotation angle of the input component of the second energy accumulator means relative to the output components of this second energy accumulator means is limited to a second relative rotation angle.

The hydrodynamic torque converter device, or the torsion vibration damper, or the first energy accumulator means are configured, so that a relative rotation of the input component of the first energy accumulator means, which corresponds to the maximum first relative rotation angle of the input component of the first energy accumulator means, relative to the output component of the first energy accumulator means, occurs, when a torque is transferred from the input component of the first energy accumulator means through the first energy accumulator means to the output component of the first energy accumulator means, wherein the torque is greater than or equal to a first threshold torque, or when a torque is applied to the first energy accumulator means, which is greater than or equal to this first threshold torque.

Furthermore, the hydrodynamic torque converter device, or the torsion vibration damper, or the second energy accumulator means are configured so that a relative rotation of the input component of the second energy accumulator means relative to the output component of the second energy accumulator, which corresponds to the maximum second relative rotation angle, occurs, when a torque is transferred from the input component of the second energy accumulator means through the second energy accumulator means to the output component of the second energy accumulator means, wherein the torque is greater than or equal to a second threshold torque, or when a torque is applied to the second energy accumulator means, which is greater than or equal to the second threshold torque.

It is provided that the first threshold torque is smaller than the second threshold torque. The hydrodynamic torque converter device or its torsion vibration damper, or the first or the second energy accumulator means are particularly configured so that the first threshold torque is smaller than the second threshold torque.

Hereby, a basis for embodiments is provided, in which the torsion vibration damper is configured so that when the converter lockup clutch is closed, a relatively good insulation or reduction of torsion vibrations or torque spikes in the partial range is facilitated without significantly impairing the fuel consumption of the motor vehicle and/or the insulation, or the reduction of torsion vibrations or torque spikes in the upper torque range. Thus, for example, a basis is created that the energy accumulators of the first energy accumulator means are configured so that they provide, possibly in conjunction with the second energy accumulators of the second energy accumulator means, a good insulation or reduction of torque spikes of a combustion engine of a motor vehicle in the partial load range, wherein the maximum first rotation angle is reached under higher torque loads, and the first energy accumulators are bridged, so that torque spikes of the combustion engine are only insulated or reduced by the second energy accumulator means. The energy accumulators of the second energy accumulator means are thus preferably provided so that they allow a comparatively good insulation or reduction of torque spikes under higher torque loads.

The hydrodynamic torque converter device according to the invention is provided for a motor vehicle drive train, or it can be a component of a motor vehicle drive train. It is provided in particular that the torsion vibration damper is rotatable about a rotation axis.

It is appreciated that a means designated herein as “converter torus”, is partially designated as “hydrodynamic torque converter” in previous publications. The designation “hydrodynamic torque converter” however is used in previous publications partially also for devices comprising a torsion vibration damper, a converter lockup clutch, and a unit formed by a pump shell, a turbine shell, and a stator shell, a converter torus according to the language of the present disclosure. In this context, the terms “hydrodynamic torque converter device” and “converter torus” are used in the present disclosure for better differentiation.

The relative rotation angle of the input component of the first energy accumulator means, relative to the output component of the first energy accumulator means, is, in particular, the relative rotation angle by which the input component of the first energy accumulator means is rotated, or pivoted relative to the output component of the first energy accumulator means, and thus with reference to the position or relative position of the two components, which occurs in the unloaded resting position of these two components, or of the torsion vibration damper, or of the first energy accumulator means, wherein the relative rotation angle of the two components in the unloaded resting position is zero degrees (0°), in particular. The relative rotation angle of the input component of the first energy accumulator means relative to the output component of the first energy accumulator means is also designated as “first relative rotation angle” in order to simplify the illustration.

The input component of the first energy accumulator means, or a component non-rotatably connected with this input component, is also designated as a second component. The input component of the first energy accumulator means can, e.g., be a plate or a flange. The output component of the second energy accumulator means can, e.g., be a plate or a flange.

It is provided that the input component of the first energy accumulator means is rotatable about the rotation axis of the torsion vibration damper, and the output component of the first energy accumulator means is rotatable about the rotation axis of the torsion vibration damper, wherein then starting with an unloaded resting position, one of the components is rotated about the rotation axis of the torsion vibration damper relative to the other of these two components, wherein the first relative rotation angle changes. The first relative rotation angle can also change by the first energy accumulators of the first energy accumulator means absorbing energy or releasing stored energy. The first relative rotation angle is limited by a maximum first relative rotation angle. This occurs, in particular, so that the input component of the first energy accumulator means cannot be rotated relative to the output component of the first energy accumulator means by an angle of any size, but at the most by a relative angle, which corresponds to the maximum first relative rotation angle, or which is the maximum first relative rotation angle.

It can be provided that between the respective support portions of the input component of the first energy accumulator means and/or the support portions of the output component of the first energy accumulator means, on the one hand, and the respective first or second ends of the first energy accumulators, on the other hand, a clearance is provided in the unloaded resting position, so that this input component is rotatable relative to this output component, thus without loading first energy accumulators. In such an embodiment, the first relative rotation angle is zero degrees (0°), in particular, when the input component and the output component of the first energy accumulator means respectively contact a respective end of the first energy accumulators of this first energy accumulator means, without loading first energy accumulators of the first energy accumulator means. It is however provided in a particularly preferred embodiment that the support portions of the input component and of the output component of the first energy accumulator means contact respective ends of the first energy accumulators in the unloaded resting position, and in particular cannot be pivoted relative to each other without thus, or thereby loading first energy accumulators.

In a preferred embodiment, all first energy accumulators of the first energy accumulator means are arranged in parallel. It can also be provided that first energy accumulators of the first energy accumulator means are connected in parallel and within the thus formed parallel branches of this parallel connection, first energy accumulators are connected in series. It can also be provided that, based on a unloaded resting position, with increasing torque loading of the first energy accumulator means, initially only a few first energy accumulators are loaded, and starting with a predetermined torque load, additionally further first energy accumulators are loaded. This can be provided, e.g., in two or three stages, or also in more than three stages.

The relative rotation angle of the input component of the second energy accumulator means relative to the output component of the second energy accumulator means is in particular the relative rotation angle, by which, with respect to the circumferential direction of the rotation axis of the torsion vibration damper, the input component of the second energy accumulator means is rotated or pivoted relative to this output component of this second energy accumulator means, and thus in particular with respect to the position or to the relative position of the two components, which is given in the unloaded resting position of the two components, or of the torsion vibration damper, or of the second energy accumulator means, wherein the relative rotation angle of these components in this unloaded resting position is zero degrees (0°), in particular. The relative rotation angle of the input component of the second energy accumulator means relative to the output component of this second energy accumulator means is also designated as “second relative rotation angle” in order to simplify the illustration.

The input component of the second energy accumulator means can be, e.g., a plate or a flange. The output component of the second energy accumulator means, or a component connected torque proof with this input component, is also designated as third component. The output component of the second energy accumulator means can be, e.g., a plate or a flange.

It is provided in particular that the input component of the second energy accumulator means is rotatable about the rotation axis of the torsion vibration damper and the output component of the second energy accumulator means is rotatable about the rotation axis of the torsion vibration damper, wherein then, based on a unloaded resting position, one of the two components is rotated about the rotation axis of the torsion vibration damper relative to the other of the two components, the second relative rotation angle changes. Thus the second relative rotation angle can also change in particular by the second energy accumulators of the second energy accumulator means absorbing energy, or releasing stored energy. The second relative rotation angle is limited by a maximum second relative rotation angle. This occurs in particular, so that the input component of the second energy accumulator means cannot be rotated by an angle of any size relative to the output component of the second energy accumulator means, but at the most by a relative angle, which corresponds to the maximum second relative rotation angle, or which is the maximum second relative rotation angle.

It can be provided that between the respective support portions of the input component of the second energy accumulator means, and/or the support portions of output component of the second energy accumulator means, on the one hand, and the respective first or second ends of the second energy accumulators, on the other hand, a clearance is provided in the unloaded resting position, so that the input component relative to the output component is rotatable, without thereby loading second energy accumulators. In such an embodiment, the second relative rotation angle is zero degrees (0°), in particular, when the input component and the output component of the second energy accumulator means respectively contact a respective end of the second energy accumulators of this second energy accumulator means without loading second energy accumulators of the second energy accumulator means.

In a particularly preferred embodiment, it is however provided that in the unloaded resting position the support portions of the input component and of the output component of the second energy accumulator means contact respective ends of the second energy accumulators, and cannot be pivoted relative to each other without thus, or thereby loading second energy accumulators.

In the preferred embodiment, all second energy accumulators of the second energy accumulator means are connected in parallel with each other. However, it can also be provided that second energy accumulators of the second energy accumulator means are connected in parallel and within the parallel paths of this parallel assembly, thus formed, second energy accumulators are connected in series. It can also be provided that based on an unloaded resting position, with increasing torque loading of the second energy accumulator means, initially only a few second energy accumulators are loaded, and starting with a predetermined torque loading, additionally more second energy accumulators are loaded. This can be provided, e.g., in two stages, or in three stages or also in more than three stages.

The torque converter lockup clutch, the first energy accumulator means and the second energy accumulator means are in particular connected in series, so that the first energy accumulator means is disposed between the torque converter lockup clutch and the second energy accumulator means.

It is provided, in particular, that the output component of the first energy accumulator means is non-rotatably connected to the input component of the second energy accumulator means. The output component of the first energy accumulator means can, e.g., be integrally configured with the input component of the second energy accumulator means. It can also be provided that the output component of the first energy accumulator means and the input of the second energy accumulator means are separate components, which are non-rotatably connected amongst each other by suitable connecting means, e.g., rivets, bolts, pins, or welds. It can further be provided that between the output component of the first energy accumulator means and the input component of the second energy accumulator means, one or several components are provided, and thus, so that the output component of the first energy accumulator means is non-rotatably connected to the input component of the second energy accumulator means, for which purpose suitable connection means, e.g., of the type, can be provided, by means of which the respective components are non-rotatably connected.

Between the first energy accumulator means and the second energy accumulator means, a first component is preferably provided, which is connected in series with these two energy accumulator means, wherein the first component is also designated as intermediary component. The intermediary component can, e.g., be the output component of the first energy accumulator means and/or the input component of the second energy accumulator means, or a component different from this output component of the first energy accumulator means and from the input component of the second energy accumulator means, which is non-rotatably connected to this output component, or to this input component. It can thus also be provided in particular that a torque can be transmitted from the first energy accumulator means through the intermediary component to the second energy accumulator means. In a particularly preferred embodiment, the turbine, or the turbine shell comprises an outer turbine dish, which is non-rotatably connected to the intermediary component.

Preferably, the first energy accumulator means are coil springs or arc springs. It is furthermore preferred that the second energy accumulators are coil springs, straight springs, or straight compression springs. In a particularly preferred embodiment, the first energy accumulators are coil springs or arc springs and the second energy accumulators are coil springs or straight springs. In the preferred embodiment, the first energy accumulators and/or the second energy accumulators act as coil springs, respectively.

According to a preferred embodiment, a second relative rotation angle limiter is provided for the second energy accumulator means, by means of which a blockage loading of the second energy accumulators of the second energy accumulator means is avoided. Thus, it is provided that by means of this second rotation angle limiter means, the second relative rotation angle is limited to the maximum second relative rotation angle. The second relative rotation angle limiter device can act, e.g., so that at the input component of the second energy accumulator means a bolt, a pin, or the like is fixated, which engages a groove or an elongated hole, which are provided in the output component of the second energy accumulator means, so that the bolt or pin stops at a relative rotation of the input component corresponding to the relative rotation of the input component of the second energy accumulator means, relative to the output component of the second energy accumulator means, at a stop formed by the end of the groove or by the elongated hole, so that an additional increase of the second relative rotation angle is avoided.

Furthermore, a first relative rotation angle limiter means for the first energy accumulator means can be provided by means of which a blockage loading of the first energy accumulators of the first energy accumulator means is avoided, and which is configured, e.g., according to the second relative rotation angle limiter means. In a particularly preferred embodiment, it is provided that when the first energy accumulators are respectively provided as respective arc springs, a blockage loading of the first energy accumulators is not avoided, and the maximum first relative rotation angle between the input component and the first energy accumulator means and the output component of the first energy accumulator means occurs, when the first energy accumulators of the first energy accumulator means have reached blockage or have substantially reached blockage.

It can be provided that the maximum second relative rotation angle is greater than the maximum first relative rotation angle. It is preferred that the first relative rotation angle is greater than the maximum second relative rotation angle.

The hydrodynamic torque converter device, or the torsion vibration damper, or the first energy accumulator means are preferably configured so that the first threshold torque is greater than 50 Nm, and smaller than 500 Nm, preferably greater than 50 Nm and smaller than 400 Nm, preferably greater than 50 Nm and smaller than 400 Nm, preferably greater than 50 Nm and smaller than 300 Nm, preferably greater than 100 Nm and smaller than 300 Nm, preferably greater than 150 Nm and smaller than 250 Nm. For example, the first threshold torque substantially amounts to 200 Nm.

According to a particularly preferred embodiment, the hydrodynamic torque converter device, or the torsion vibration damper, or the first and the second energy accumulator means are configured, so that the second threshold torque is greater than 1.25× the first threshold torque, preferably greater than 1.5× the first threshold torque, preferably greater than 1.75× the first threshold torque, preferably greater than 2× the first threshold torque, preferably greater than 2.5× the first threshold torque, preferably greater than 3× the first threshold torque, preferably greater than 3.5× the first threshold torque, preferably greater than 4× the first threshold torque, preferably greater than 4.5× the first threshold torque, preferably greater than 5× the first threshold torque, and most preferably greater than 6× the first threshold torque.

It can be provided that the second threshold torque is greater than 300 Nm, preferably greater than 350 Nm, preferably greater than 400 Nm, preferably greater than 450 Nm, preferably greater than 500 Nm, preferably greater than 550 Nm, preferably greater than 600 Nm, preferably greater than 650 Nm, preferably greater than 700 Nm, preferably greater than 750 Nm, preferably greater than 800 Nm, preferably greater than 850 Nm, and most preferably greater than 1000 Nm.

In a preferred embodiment, it is provided that the spring constant of the second energy accumulator means is greater than 1.25 fold, preferably greater than 1.5 fold, preferably greater than 2 fold, preferably greater than 3 fold, preferably greater than 3.5 fold, preferably greater than 2.5 fold, preferably greater than 4.5 fold, preferably greater than 5 fold, preferably greater than 6 fold, preferably greater than 7 fold, and most preferably greater than 8 fold the spring constant of the first energy accumulator means.

According to a preferred embodiment, the hydrodynamic torque converter device is provided for a motor vehicle drive train, which comprises a combustion engine, wherein the second threshold moment is greater than the maximum engine moment of this combustion engine. In an alternative embodiment, the hydrodynamic torque converter device is provided for a motor vehicle drive train, which comprises a combustion engine, wherein the second threshold moment is smaller than the maximum engine moment of this combustion engine. It can also be provided, in any of the aforementioned embodiments, that the second threshold torque corresponds to the maximum engine torque of the combustion engine. Thus, it can be provided that the maximum engine moment of this combustion engine has the ratio compared to the second threshold moment. The torque converter device of such a motor vehicle drive train according to the invention can be configured according to the invention and, in particular, also according to improvements of the invention.

It is the object of the invention to provide a hydrodynamic torque converter device for a motor vehicle drive train that it is well-suited for partial load operation of a motor vehicle.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a partial, cross-sectional view of a first embodiment of the present invention hydrodynamic torque converter device;

FIG. 2 is a partial, cross-sectional view of a second embodiment of the hydrodynamic torque converter device;

FIG. 3 is a partial, cross-sectional view of a third embodiment of the hydrodynamic torque converter device;

FIG. 4 is a partial, cross-sectional view of a fourth embodiment of the hydrodynamic torque converter device;

FIG. 5 is a partial, cross-sectional view of a fifth embodiment of the hydrodynamic torque converter device;

FIG. 6 is a partial, cross-sectional view of a sixth embodiment of the hydrodynamic torque converter device;

FIG. 7 is a partial, cross-sectional view of a seventh embodiment of the hydrodynamic torque converter device; and,

FIG. 8 is a partial, cross-sectional view of an eighth embodiment of the hydrodynamic torque converter device according to the invention.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

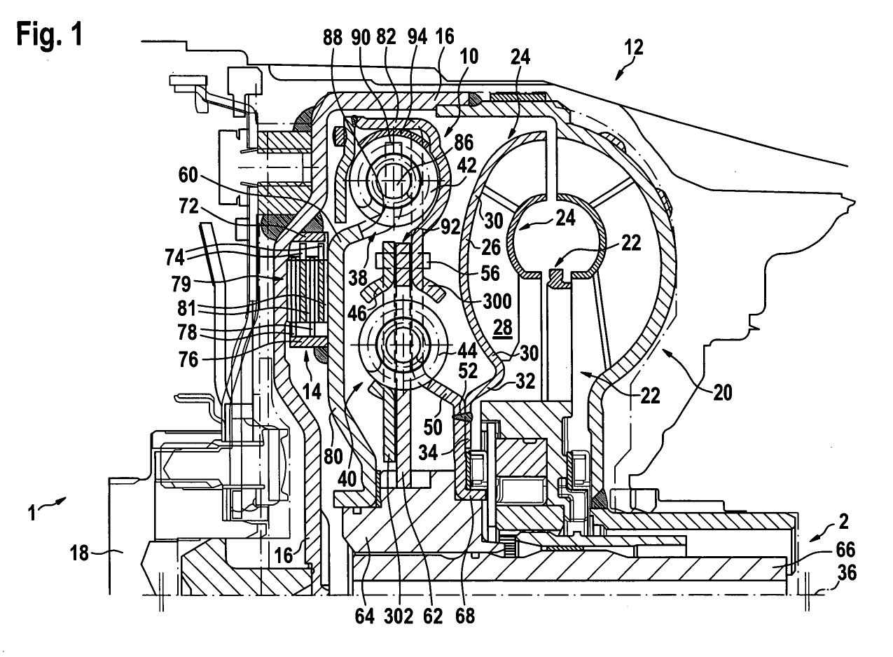

FIGS. 1-8 show various exemplary embodiments of hydrodynamic torque converter device 1 according to the invention. Hydrodynamic torque converter devices 1 illustrated therein can be respectively integrated in motor vehicle drive train 2, or can be components of motor vehicle drive train 2.

As shown in FIGS. 1-8, hydrodynamic torque converter device 1 comprises torsion vibration damper 10, converter torus formed by pump shell 20, turbine shell 24, and stator shell 22, and comprises converter lockup clutch 14.

Torsion vibration damper 10, converter torus 12, and converter lockup clutch 14 are received in converter housing 16. Converter housing 16 is substantially non-rotatably connected with drive shaft 18, which is, e.g., the crankshaft, or the engine output shaft of a combustion engine.

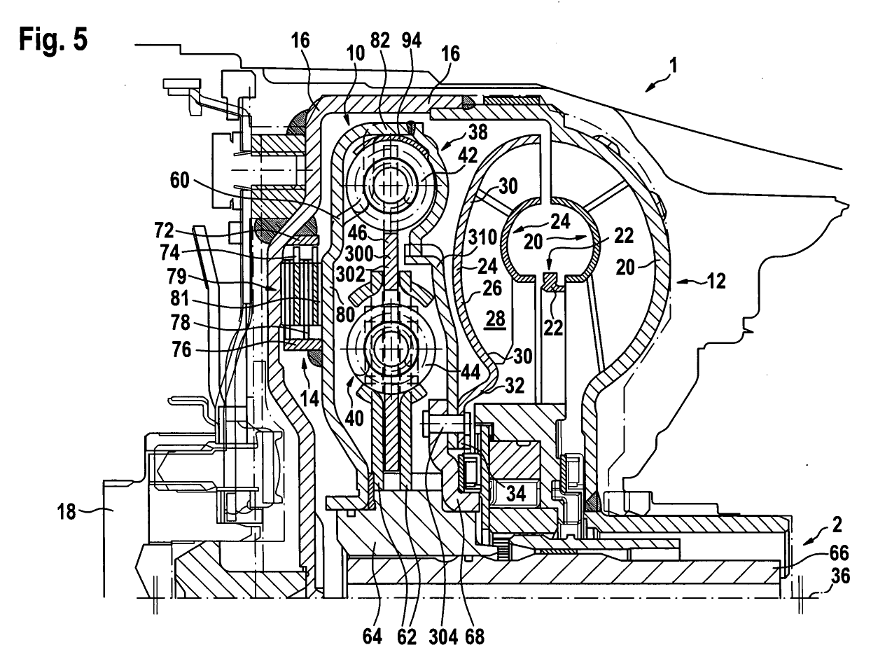

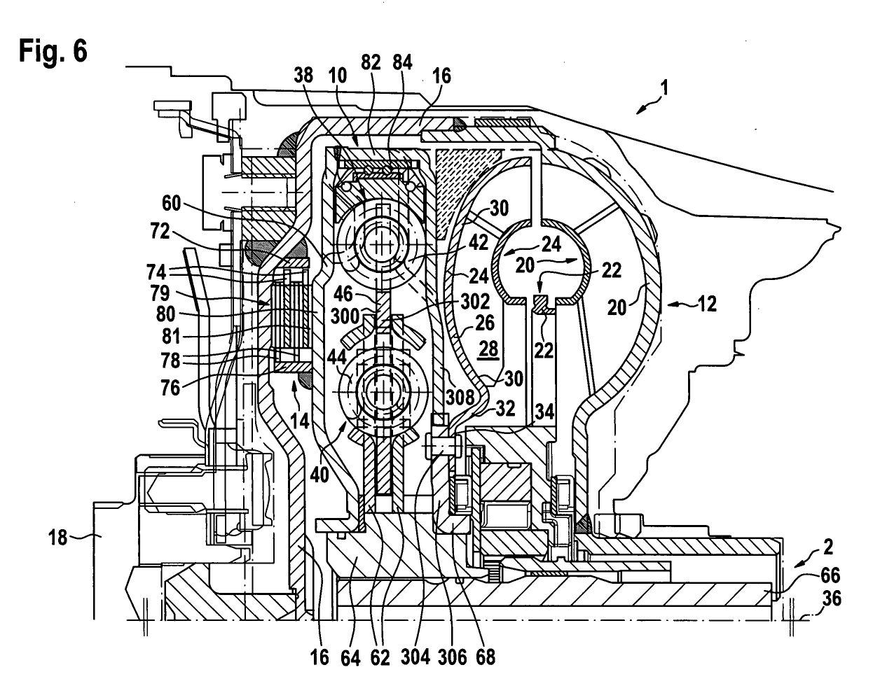

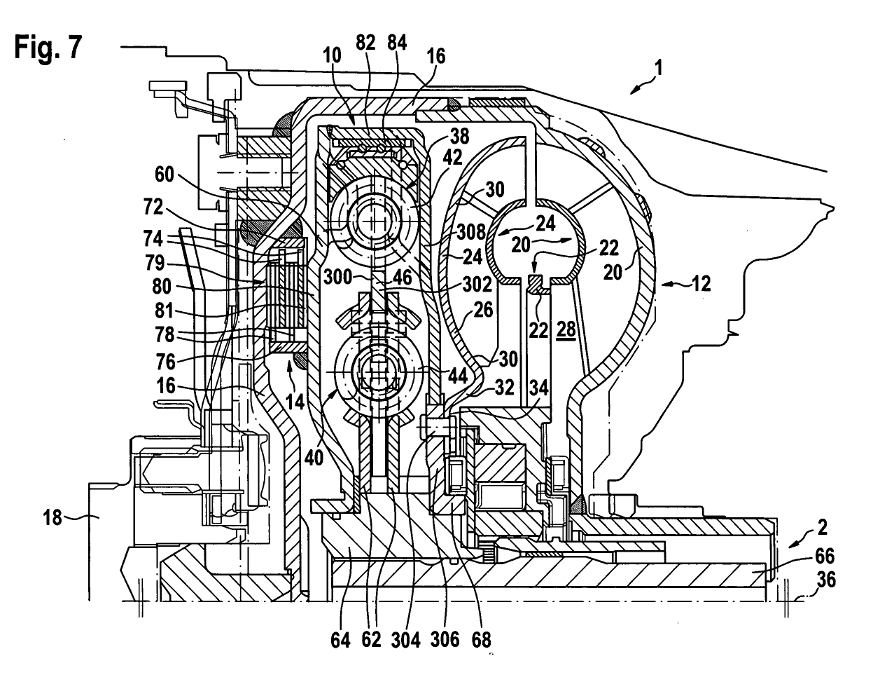

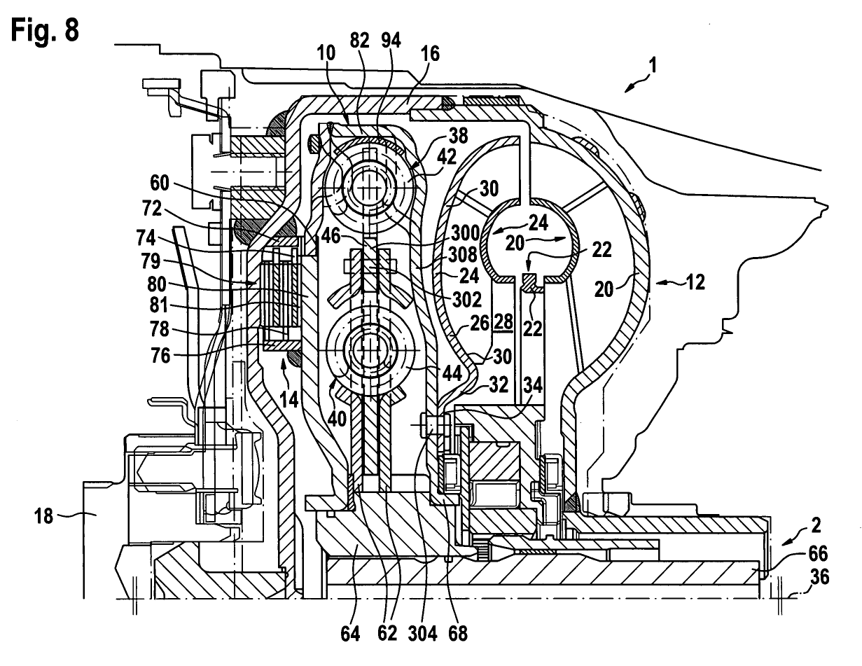

In a known manner, converter torus 12 comprises a converter torus inner cavity, or torus interior 28, which are provided, e.g., for receiving oil, or a through-flow of oil. Turbine shell 24 comprises outer turbine dish 26, forming wall section 30 directly abutting to interior 28 of the torus, and forming wall section 30 provided for defining torus interior 28. Extension 32 of outer turbine dish 26 connects to wall section 30, directly abutting to interior 28 of the torus. Extension 32 and wall section 30 are integrally provided, or made of an integral part. Extension 32 comprises straight or annular section 34. Straight or annular section 34 of extension 32 can, e.g., be provided so that it is substantially straight in radial direction of rotation axis 36 of torsion vibration damper 10 and can be provided, in particular, as an annular section, disposed in a plane, which is perpendicular to rotation axis 36, or defines this plane. In the portion of extension 32, or of straight or annular section 34 of extension 32, a non-rotatable connection is established by connection means 52 and/or 54, as shown in FIGS. 1-4, or 304, as shown in FIGS. 5-8, with one, or at least one component 50, as shown in FIGS. 1-4, 310, as shown in FIG. 5, 306, as shown in FIGS. 6 and 7, or 308, as shown in FIG. 8, which is adjacent in the torque flow. Hereby, it is facilitated that the turbine, or turbine shell 24, or outer turbine dish 26 can be easily and non-rotatably connected to subsequently connected components in the torque flow. With a non-rotatable connection of outer turbine dish 26 to components connected subsequent to turbine dish 26 in the portion of wall section 30, there is, for example, a lesser risk of thermal warping in the portion of wall section 30, or the blades of the turbine, if the non-rotatable connection is performed by welding. However, also the selection of possible connection means is increased by the non-rotatable connection in the portion of extension 32.

Torsion vibration damper 10 comprises first energy accumulator means 38 and second energy accumulator means 40. First energy accumulator means 38 and/or second energy accumulator means 40 are, in particular, spring means.

In the embodiments shown in FIGS. 1-8, it is provided that first energy accumulator means 38 comprises several first energy accumulators 42 in a circumferential direction extending about rotation axis 36, which are disposed at a distance to each other and are, in particular, coil springs or arc springs. It can be provided that all first energy accumulators 42 are identical. Differently configured first energy accumulators 42 can also be provided.

Second energy accumulator means 40 comprises several second energy accumulators 44, respectively provided as a coil springs, straight springs, or straight compression springs. Thus, in a preferred embodiment, all or several second energy accumulators 44 are disposed at a distance from one another with reference to the circumferential direction of rotation axis 36. It can be provided that second energy accumulators 44 are identical. Various second energy accumulators 44, however, can also be provided.

According to the embodiments shown in FIGS. 1-8, second energy accumulator means 40 is disposed with reference to the radial direction of rotation axis 36 radially within first energy accumulator means 38. Second energy accumulator means 40 is connected in series with first energy accumulator means 38. Torsion vibration damper 10 comprises first component 46, which is disposed between first energy accumulator means 38 and second energy accumulator means 40, or connected in series with these energy accumulator means 38 and/or 40. Thus it is provided that in converter lockup clutch 14, a torque can be transferred from first energy accumulator means 38 through first component 46 to second energy accumulator means 40. First component 46 can also be designated as intermediary component 46.

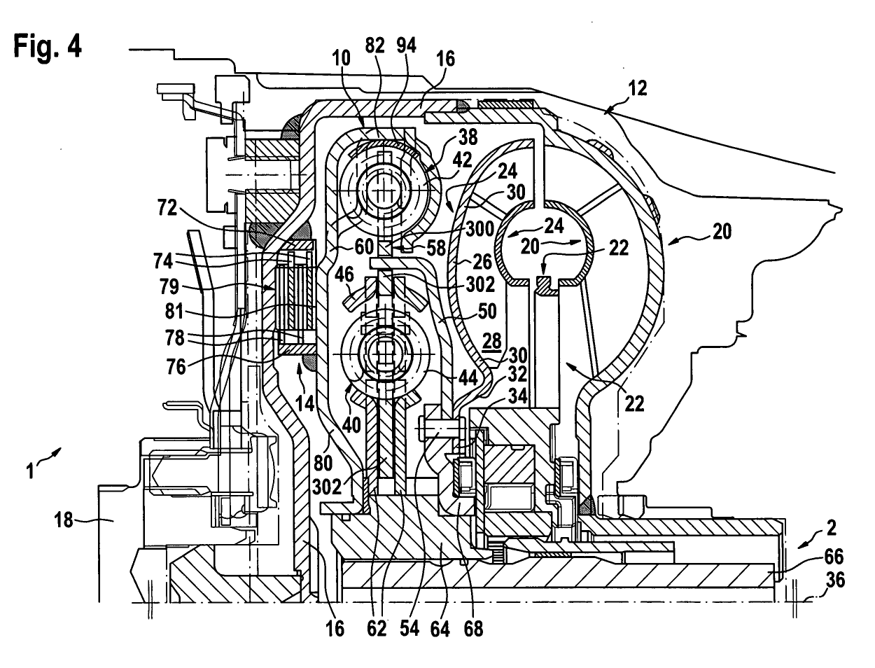

Second component 60 and third component 62 are connected in series with first energy accumulator means 38, second energy accumulator means 40 and intermediary component 46, provided between energy accumulator means 38 and 40. Second component 60 forms an input component of first energy accumulator means 38 and third component 62 forms an output component of second energy accumulator means 40. A torque transferred by second component 60 into first energy accumulator means 38 can thus be transferred at the output of first energy accumulator means 38 through intermediary component 46 and second energy accumulator means 40 to third component 62. In the embodiments shown in FIGS. 4-8, two respective third components or output components 62 of second energy accumulator means 40 are provided, which are connected in parallel and non-rotatably connected amongst each other.

Output component 300 of first energy accumulator means 38 is provided and input component 302 of second energy accumulator means 40. In the embodiments shown in FIGS. 1-3, output component 300 of first energy accumulator means 38, and input component 302 of second energy accumulator means 40, are separate components non-rotatably connected amongst each other, e.g., by means of one or several connection means 56 or 58, which, e.g., comprise a bolt or pin, or which are formed by such bolt or pin, as shown in FIGS. 1-3.

In the embodiments shown in FIGS. 1-3, output component 300 of first energy accumulator means 38 is formed by driver component 50. Input component 302 of second energy accumulator means 40 is formed in the embodiments shown in FIGS. 1-3 by intermediary component 46 or the first component. In the embodiments shown in FIGS. 4-8, output component 300 of first energy accumulator means 38 and input component 302 of second energy accumulator means 40 are formed by the same component, which is the first component or intermediary component 46 in this case.

Input component 60 of first energy accumulator means 38 forms support portions, by which first energy accumulators 42 can be supported or loaded at their first ends. Output component 300 of first energy accumulator means 38 forms support portions, by means of which the respective first energy accumulators 42 can be supported or loaded at their second ends, which are the ends facing away from the respective first ends. Input component 302 of second energy accumulator means 40 forms support portions, by means of which second energy accumulators 44 can be supported or loaded at their first ends. Output component 62 of second energy accumulator means 40 forms support portions, by means of which second energy accumulators 44 can be supported or loaded at their second ends, which are the ends respectively facing away from the respective first ends.

Third component(s) 62 engage hub 64, forming a non-rotatable connection, wherein hub 64 is non-rotatably coupled with output shaft 66 of torque converter device 1, which is, e.g., a transmission shaft of a motor vehicle. Outer turbine dish 26 is radially supported at hub 64 by means of support section 68. Support section 68 is substantially sleeve-shaped. Support section 68 is non-rotatably connected with outer turbine shell 26. Support section 68 or outer turbine shell 26 are rotatably movable relative to hub 64. A straight bearing, a straight bearing bushing, a roller bearing, or the like may be provided between hub 64 and support section 68, for radial support. Furthermore, respective bearings can be provided for an axial support.

Converter lockup clutch 14 is provided in the embodiments shown in FIGS. 1-8 as a multi-disk clutch and comprises first disk carrier 72 which receives first disks 74 in a non-rotatable manner, and second disk carrier 76 which receives second disks 78 in a non-rotatable manner. When multi-disk clutch 14 is open, first disk carrier 72 is movable relative to second disk carrier 76, so that first disk carrier 72 can be rotated relative to second disk carrier 76. Second disk carrier 76 is disposed here with reference to the radial direction of axis 36, radially within first disk carrier 72, but it can also be the other way around. First disk carrier 72 is attached to converter housing 16. For actuation, multi-disk clutch 14 comprises piston 80, which is disposed axially movable, and which can be loaded for actuating multi-disk clutch 14, e.g., hydraulically. Piston 80 is non-rotatably attached or mounted to second disk carrier 76, which can be effectuated, e.g., by means of a weld. First disks 74 and second disks 78 alternate when viewed in a longitudinal direction of rotation axis 36. When loading disk packet 79 formed by first disks 74 and by second disks 78 by means of piston 80, disk packet 79 is supported on the side of disk packet 79 opposite to piston 80 at a section of the inside of converter housing 16. Between adjacent disks 74 and 78, and on both ends of disk packet 79, friction liners 81 are provided, which are, e.g., held at disks 74 and/or 78. Friction liners 81, which are provided at the end of disk packet 79, can be held on the one and/or the other side and also on the inside of converter housing 16, or at piston 80.

Piston 80 is integrally formed with second component 60, thus input component 60 of first energy accumulator means 38, or non-rotatably connected with input component 60. Piston 80, or second component 60, the first component, or intermediary component 46, third component 62, as shown in FIGS. 1-4, and driver component 50 are formed by plates respectively. Second component 60 is a flange, in particular. The first component is a flange, in particular. Third component 62 is a flange in particular.

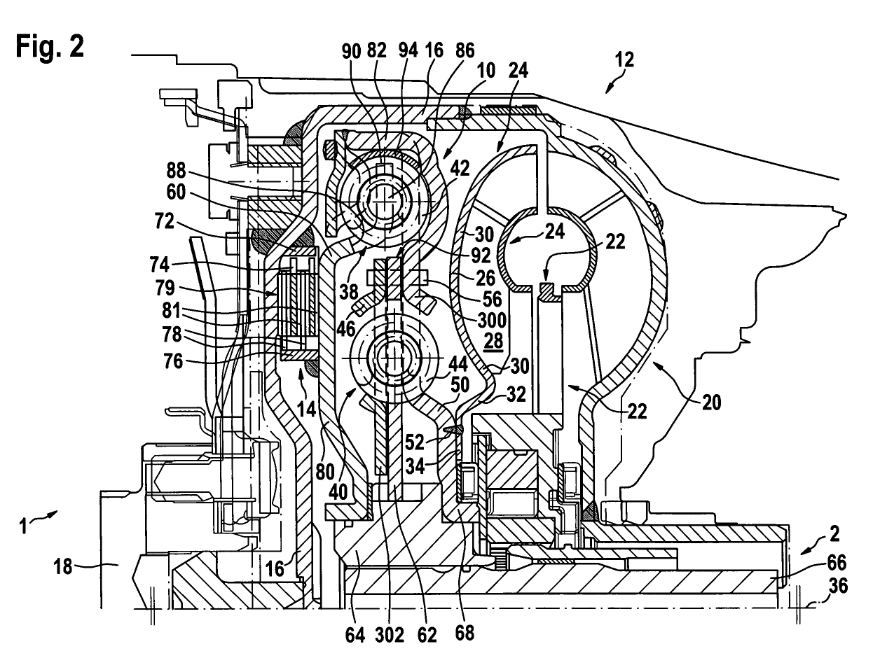

In the embodiments shown in FIGS. 1-3, the moment of inertia of driver component 50 is greater than the moment of inertia of piston 80, or of input component 60 of first energy accumulator means 38, or of unit made of components 60 and 80. In the embodiment shown in FIG. 2, the plate thickness of driver component 50 is greater than the plate thickness of piston 80, or of input component 60 of first energy accumulator means 38. It is appreciated that the vibration characteristics in the embodiment shown in FIG. 4 are worse than in the embodiments shown in FIGS. 1-3. In the embodiment shown in FIG. 2, the vibration characteristics of device 1 are particularly good.

For first energy accumulators 42, housing, or respective housing 82 is formed, which extends with reference to the radial direction and to the axial direction of rotation axis 36, e.g., at least partially on both sides in axial direction and radially on the outside around respective first energy accumulator 42. In the embodiments shown in FIGS. 1-3, housing 82 is non-rotatably attached or connected to driver component 50, while it is disposed at piston 80 in the embodiments shown in FIGS. 4-8.

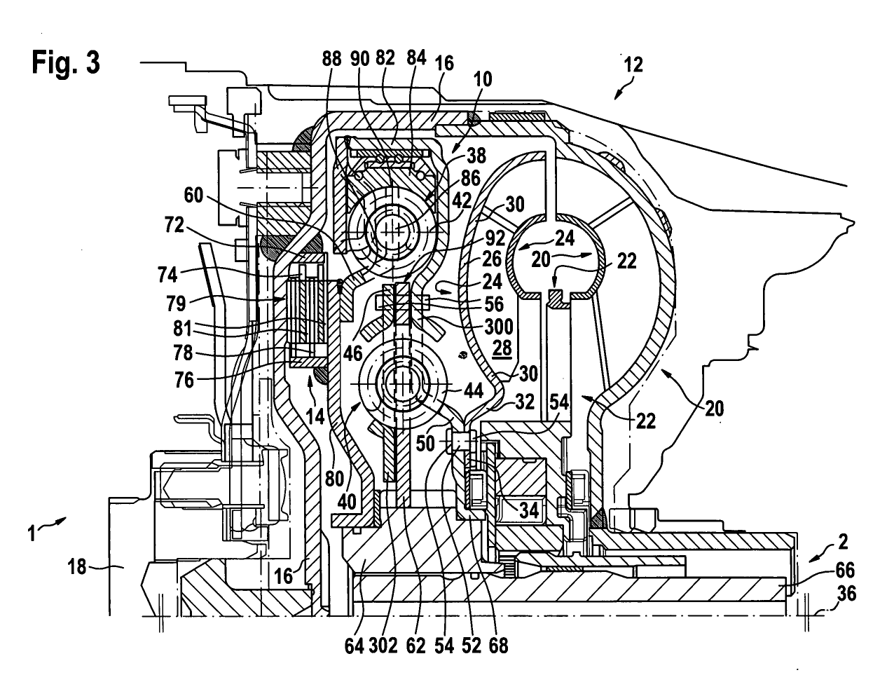

In the embodiments shown in FIGS. 3, 6, and 7, first energy accumulators 42 can be supported at housing 82 for friction reduction by device 84, designated as a roller shoe, comprising roller bodies like balls or rollers. Though it is not shown in FIGS. 1, 2, 4, 5, and 8, such means 84, comprising roller bodies like balls or rollers for supporting first energy accumulators 42, can be accordingly provided for friction reduction also in the embodiments shown in these figures. According to the embodiments shown in FIGS. 1, 2, 4, 5, and 8, however, slider dish or slider shoe 94 is provided instead of such roller shoe 84 for a low friction support of first energy accumulators 42.

In the embodiments shown in FIGS. 1-4, outer turbine dish 26 is non-rotatably connected with intermediary component 46 or with output component 300 of first energy accumulator means 38, or with input component 302 of second energy accumulator means. This facilitates, in particular, that a load, for example, a torque and/or a force, can be transferred from outer turbine dish 26 to intermediary component 46. Between outer turbine dish 26 and intermediary component 46, or in the load flow, in particular torque or force flow between outer turbine dish 26 and intermediary component 46, driver component 50 is provided in the embodiments shown in FIGS. 1-4. It can also be provided in the embodiments shown in FIGS. 1-4 that extension 32 forms intermediary component 46 and/or driver component 50, or takes over their function. It can also be provided that driver component 50 forms a first component, or intermediary component 46, which is connected in series in the torque flow between energy accumulator means 38 and 40.

In the embodiments shown in FIGS. 5-8, outer turbine dish 26 is rotatably connected with intermediary component 46, unlike in the embodiments shown in FIGS. 1-4. In the embodiments shown in FIGS. 5-8, outer turbine dish 26 is non-rotatably connected to input component 60 of first energy accumulator 38.

In the embodiments shown in FIGS. 1-3, piston 80, or the second component, or input component 60 of first energy accumulator means 38 form several ears 86, distributed over the circumference, each comprising non-free end 88 and free end 90, and which are provided for the end- or face side input load of a respective first energy accumulator 42. Non-free end 88 is thus, with reference to the radial direction of rotation axis 36, disposed radially within free end 90 of the respective ear 86. At ears 86, the support portions of input component 60 of first energy accumulator 38 are formed, which are configured for supporting or loading first energy accumulators 42 at input component 60.

In the embodiments shown in FIGS. 1-8, the respective input component 60 of first energy accumulator means 38 can be rotated relative to output component 300 of first energy accumulator means 38, and thus about rotation axis 36. This can be performed, in particular, so that first energy accumulators 42 absorb energy when the relative rotation angle between input component 60 of first energy accumulator means 38 and output component 300 of first energy accumulator means 38 becomes smaller and release energy, when the relative rotation angle between input component 60 of first energy accumulator means 38 and output component 300 of first energy accumulator means 38 becomes larger. This relative rotation angle between input component 60 of first energy accumulator means 38 and output component 300 of first energy accumulator means 38, which is also designated as first relative rotation angle, is limited to a maximum first relative rotation angle.

In the embodiments shown in FIGS. 1-8, furthermore respective input component 302 of second energy accumulator means 40 can be rotated relative to output component 62 of second energy accumulator means 40, and thus about rotation axis 36. This can be performed so that second energy accumulators 44 absorb energy when the second relative rotation angle between input component 302 and second energy accumulator means 40 and output component 62 of second energy accumulator means 40 is reduced, and release energy, when the relative rotation angle between input component 302 of second energy accumulator means 40 and output component 62 of second energy accumulator means 40 is increased. This relative rotation angle between input component 302 of second energy accumulator means 40 and output component 62 of second energy accumulator means 40, which is also designated as second relative rotation angle, is limited to a maximum second relative rotation angle.

Torsion vibration damper 10 is configured respectively according to the embodiments shown in FIGS. 1-8, so that a relative rotation of input component 60 corresponding to the maximum first rotation angle of first energy accumulator means 38 relative to output component 300 of first energy accumulator means 38 is given when a torque is transferred from input component 60 of first energy accumulator means 38 through first energy accumulator means 38 to output component 300 of first energy accumulator means 38, which is greater than or equal to a first threshold moment, or when a torque is applied to first energy accumulator means 38, which is greater than or equal to the first threshold moment.

Torsion vibration damper 10 and, in particular, first energy accumulator means 38 are configured according to the embodiments shown in FIGS. 1-8, so that first energy accumulators 42 of first energy accumulator means 38, or at least some of first energy accumulators 42 are completely loaded until they block, when a torque is transferred from input component 60 of first energy accumulator means 38 through first energy accumulator means 38 to output component 300 of first energy accumulator means 38, which corresponds to the first threshold moment, or when a torque is applied to first energy accumulator means 38, which corresponds to the first threshold torque.

Since first energy accumulators 42 are loaded until they block, a further increase of the first relative rotation angle to values, which are above the maximum first relative rotation angle, is avoided. When the torque transferred from input component 60 of first energy accumulator means 38 through energy accumulator means 38 to output component 300 of first energy accumulator means 38, or the torque applied to first energy accumulator means 38, are further increased to values which are greater than the first threshold moment, first energy accumulator means 42 remain “in blockage”, so that a further increase of the first relative rotation angles to values, which are above the maximum first relative rotation angle, is avoided. Through loading first energy accumulators 42, or some of first energy accumulators 42, until they block, the first relative rotation angle is limited to the maximum first relative rotation angle.

Torsion vibration damper 10, according to the embodiments shown in FIGS. 1-8, is furthermore respectively configured, so that a relative rotation of input component 302 of second energy accumulator means 40, corresponding to the maximum second relative rotation angle relative to output component 62 of second energy accumulator means 40 is given, when a torque is transferred from input component 302 of second energy accumulator means 40 through second energy accumulator means 40 to output component 62 of second energy accumulator means 40, which is greater or equal to a second threshold moment, or when a torque is applied at second energy accumulator means 40, which is greater than or equal to the second threshold moment.

According to the embodiments shown in FIGS. 1-3, second relative rotation angle limiter means 92 for second energy accumulator means 40 is provided, by means of which the second relative rotation angle of input component 302 of second energy accumulator means 40 relative to output component 62 of second energy accumulator means 40 is limited to the maximum second relative rotation angle. It should be appreciated that, while not included in the embodiments as shown in FIGS. 4-8, these elements can be included therein, as described infra.

Thus, it is provided that the second relative rotation angle is limited by second relative rotation angle limiter means 92, so that it is avoided that second energy accumulator means 44, which are springs, are loaded until they block according to the high torque loading. Second relative rotation angle limiter means 92 is configured, as shown in FIGS. 1-3, so that driver component 50 and intermediary component 46 are non-rotatably connected by means of a bolt, which is a component of connection means 56, in particular, wherein the bolt extends through a slotted hole, or into a groove, which are provided in output component 62 of second energy accumulator means 40, or in third component 62.

When a torque is transferred from input component 302 of second energy accumulator means 40 through second energy accumulator means 40 to output component 62 of second energy accumulator means 40, which corresponds to the second threshold torque, or a torque is applied to second energy accumulator means 40, which corresponds to the second threshold torque, second relative rotation angle limiter means 92 reaches a stop position, which avoids that the second relative rotation angle is increased further. The relative rotation angle, which is present when reaching the stop position between input component 302 of second energy accumulator means 40 and output component 62 of second energy accumulator means 40, is the maximum second relative rotation angle.

As described supra, relative rotation angle limiter means 92 can also be present in the embodiments shown in FIGS. 4-8, which, however, is not shown in these figures. In the embodiments shown in FIGS. 5-8, for example, one or several bolts or pins can be provided, which non-rotatably connect the two output components 62 of second energy accumulator means 40 and extend through a respective slotted hole or a groove provided in input component 302 of second energy accumulator means 40.

A first relative rotation angle limiter means for first energy accumulator means 38 can be provided, which is not shown in the figures, by which the maximum first relative rotation angle is limited to a maximum first relative rotation angle and a blockage loading of first energy accumulators 42 is avoided. It can be furthermore provided that the second relative rotation angle is limited to the second maximum relative rotation angle by second energy accumulator 44 going into blockage in a relative position of input component 302 of second energy accumulator means 40 relative to output component 62 of second energy accumulator means 40, corresponding to the second maximum relative rotation angle.

In embodiments in which second energy accumulators 44 are straight springs or straight compression springs, and first energy accumulators 42 are arc springs, as is the case in the embodiments shown in FIGS. 1-8, it is particularly advantageous, when, as shown in the FIGS. 1-3, and preferably in the embodiments shown in FIGS. 4-8 (though not shown), only second relative rotation angle limiter means 92 for second energy accumulator means 40 is provided, since when arc springs are loaded until they go into blockage, the risk of damages is less in case of arc springs than in case of straight springs, and an additional first relative rotation angle limiter means would increase the numbers of components, or the manufacturing cost.

While the second relative rotation angle is thus limited by means of second relative rotation angle limiter device 92 to the maximum second relative rotation angle, the first relative rotation angle is thereby limited to the maximum first relative rotation angle, so that first energy accumulator 42 goes into blockage at a first relative rotation angle, corresponding to the first maximum relative rotation angle.

The embodiments shown in FIGS. 1-8 facilitate, in particular, a good adjustment for partial load operation. Partial load operation is approximately the range where the fuel dosage means of a motor vehicle is in a position range of approximately ten percent (10%) to approximately fifty percent (50%). However, deviations from these values can occur. In order to insulate or reduce rotation variations of the combustion engine in this range in a satisfactory manner, torsion vibration damper 10 can be set very soft in principle, or it can be provided with a low spring constant. This, however, would have detrimental effects upon the vibration insulation or reduction in the upper torque ranges of the combustion engine. Alternatively, in case of a torque transfer through the converter lockup clutch, the lockup clutch can be operated with slippage, or with a high slippage. This, however, would have a detrimental effect on the fuel consumption of the vehicle.

In the embodiments shown in FIGS. 1-8, means are provided to insulate rotation irregularities of the combustion engine in partial load operation well, or to reduce them without causing excessively high fuel consumption or a particularly bad vibration insulation, or no vibration insulation or reduction in the upper torque range. For this purpose, the spring constant of first energy accumulator means 38 can be selected low, so that, in partial load operation with torque converter lockup clutch 14 closed, rotation irregularities of the combustion engine can be insulated particularly well, or can be reduced. The spring constant of second energy accumulator means 40, however, can be selected relatively large in order to be able to reduce or insulate vibrations, possibly quite well, also in the upper torque range of the combustion engine. Thus, it is provided in particular that in this upper torque range the maximum first relative rotation angle of input component 60 of the first energy accumulator means is reached relative to output component 300, so that the low spring rate of the first energy accumulator means does not substantially develop any effect in this upper torque range, or the first energy accumulators are bridged.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

### DESIGNATIONS

1 hydrodynamic torque converter device
2 motor vehicle drive train
10 torsion vibration damper
12 converter torus
14 converter lockup clutch
16 converter housing
18 drive shaft, e.g. engine output shaft of a combustion engine
20 pump or pump shell
22 stator shell
24 turbine or turbine shell
26 outer turbine dish
28 interior of torus
30 wall section of 26
32 extension 30 of 26
34 straight section of 32 or annular disk shaped section of 32
36 rotation axis of 10
38 first energy accumulator means
40 second energy accumulator means
42 first energy accumulator
44 second energy accumulator
46 first component of 10
50 driver component
52 connection means or weld between 32 and 50
54 connection means or bolt or rivet connection between 32 and 50
56 connection means or bolt or rivet connection between 50 and 46
58 connection means or plug-in connection between 50 and 46
60 second component; input component of 38
62 third component; output component of 40
64 hub
66 output component, transmission input shaft
68 support section
72 first disk carrier of 14
74 first disk of 14
76 second disk carrier of 14
78 second disk of 14
79 disk packet of 14
80 piston for actuating 14
81 friction liner of 14
82 housing
84 roller shoe
86 ear
88 non-free end of 82
90 free end of 82
92 relative second rotation angle limiter means of 40
94 slider shoe
300 output component of 38
302 input component of 40
304 connection means
306 component
308 component
310 component

1-9. (canceled)

10. A hydrodynamic torque converter device for a motor vehicle drive train, wherein the hydrodynamic torque converter device comprises:
a torsion vibration damper comprising: a first energy accumulator means including at least one first energy accumulator having a first end and a second end, the first end being opposed to the second end, an input component having a plurality of support portions arranged to support the first end of the at least one first energy accumulator, and an output component having a plurality of support portions arranged to support the second end of the at least one first energy accumulator; and, a second energy accumulator means, having at least one second energy accumulator having a first end and a second end, the first end being opposed to the second end, an input component having a plurality of support portions arranged to support the first end of the at least one second energy accumulator, and an output component having a plurality of support portions arranged to support the second end of the at least one second energy accumulator;
a converter torus comprising: a pump shell; a turbine shell; and, a stator shell; and,
a converter lockup clutch, wherein a rotation angle of the input component of the first energy accumulator means, relative to the output component of the first energy accumulator means, is limited to a maximum first relative rotation angle, wherein a rotation angle of the input component of the second energy accumulator means, relative to the output component of the second energy accumulator means, is limited to a maximum second relative rotation angle, wherein the torsion vibration damper is arranged such that a rotation of the input component of the first energy accumulator means relative to the output component of the first energy accumulator means corresponds to the maximum first relative rotation angle when a first torque is transferred by the input component of the first energy accumulator means, through the first energy accumulator means, to the output component of the first energy accumulator means, wherein the first torque is greater than or equal to a first threshold torque, wherein the torsion vibration damper is arranged such that a rotation of the input component of the second energy accumulator means relative to the output component of the second energy accumulator means corresponds to the maximum second relative rotation angle when a second torque is transferred from the input component of the second energy accumulator means, through the second energy accumulator means, to the output component of the second energy accumulator means wherein the second torque is greater than or equal to a second threshold torque, and wherein the first threshold torque is less than the second threshold torque.

11. The hydrodynamic torque converter device recited in claim 10, wherein the at least one first energy accumulator is an arc spring, and the at least one second energy accumulator is a straight spring.

12. The hydrodynamic torque converter device recited in claim 10, wherein the rotation angle of the input component of the first energy accumulator means, relative to the output component of the first energy accumulator means, equals the maximum first relative rotation angle when the at least one first energy accumulator is substantially in a blockage position.

13. The hydrodynamic torque converter device recited in claim 10, wherein the first threshold torque is greater than 50 Nm and less than 400 Nm, and preferably substantially 200 Nm.

14. The hydrodynamic torque converter device recited in claim 13, wherein the first threshold torque is substantially 200 Nm.

15. The hydrodynamic torque converter device recited in claim 10 further comprising a second relative rotation angle limiter means associated with the second energy accumulator means, wherein the second relative rotation angle limiter means is operatively arranged to prevent a blockage loading of the at least one second energy accumulator.

16. The hydrodynamic torque converter device recited in claim 10, wherein the maximum first relative rotation angle is greater than the maximum second relative rotation angle.

17. The hydrodynamic torque converter device recited in claim 10, wherein the maximum second relative rotation angle is greater than the maximum first relative rotation angle.

18. The hydrodynamic torque converter device recited in claim 10 further comprising at least one first component arranged between, and serially connected with, the first energy accumulator means and the second energy accumulator means, wherein the turbine shell comprises an outer turbine dish, and wherein the outer turbine dish is non-rotatably connected to the at least one first component.

19. The hydrodynamic torque converter device recited in claim 10, wherein the second threshold torque is greater than 1.25 times the first threshold torque.
